(19) United States
(12) Patent Application Publication
(10) Pub. No.: US 2012/0091279 A1
(43) Pub. Date: Apr. 19, 2012

(54) Space Station Pyramid Structure

(76) Inventor: Supawadee Tesin, Lansdowne, PA (US)

(21) Appl. No.: 13/374,265

(22) Filed: Feb. 11, 2010

(51) Int. Cl. B64G 1/12; B64G 1/64

(52) U.S. Cl. 244/158.5; 244/171.9

(57) ABSTRACT

The space station pyramid design is to be erected around an Earthbound land mass (i.e. homes, towns and sanctuaries), thereby, encapsulating the land mass. Propulsion systems will raise the station into Earth's orbit. Artificial gravitation is provided through electrostatic forces within the structure.

### BACKGROUND OF THE INVENTION

The present invention relates to space stations, particularly to a space station facility having a pyramid structure which is erected on Earth's surface so as to encapsulate an Earthbound land mass.

For many, the concept of creating such a large space station structure, which would require enormous lift power to launch into orbit, is viewed as inconceivable; however, current developments in alternative propulsion systems warrants a new perspective to space station design and purpose.

Our present path to space habitation requires years of preparation and billions of dollars to safety launch astronauts and materials into space to painstakingly assemble complex and delicate machinery in dangerous conditions. Although past and current missions to space are necessary and provide great technological advances, they are also time consuming, costly and dangerous. Therefore, establishing a space station structure from the ground would be a beneficial approach in addition to any manned spacecraft missions.

The ultimate purpose for creating a future space station is for the survival of mankind. When we are confronted with a future event which could destroy all life on our planet, we need to respond quickly and effectively. Perhaps in the future we would have colonized Mars or even Europa and navigate ourselves there on space shuttles; however, we may be looking back at the Earth after its destruction and think about the billions of lives who could not be evacuated in time; we would think about the history and culture left behind.

Therefore, the ultimate future space station should be easily assembled, house large populations and preserve mankind's culture and history.

### SUMMARY OF THE INVENTION

The present invention is a space station structure that is to be erected around an Earthbound land mass such as a house, town or sanctuary. The structure, which consists of a pyramid design, is constructed primarily of a synthetic rubber polymer for ease of assembly. All life support systems are contained within the structure and include, air/water quality, energy production, food production and artificial gravity.

### DESCRIPTION OF THE DRAWING

FIG. 1 is a perspective view of the space station pyramid structure.

### DESCRIPTION OF THE PREFERRED EMBODIMENT

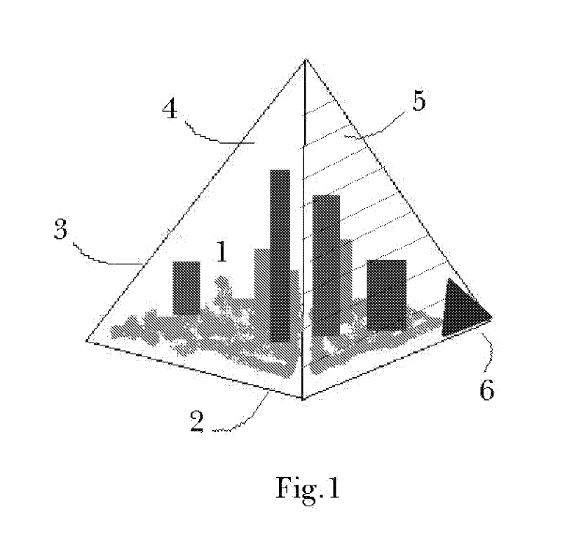

A preferred embodiment of the space station pyramid of the present invention is shown in FIG. 1. A synthetic rubber polymer base 2 is infused beneath a land mass 1 containing life support systems. Pyramid vertical edges 3, consisting of a tubular waterproof fabric, funnels the synthetic rubber polymer solution to the apex of the pyramid where it is released and cascades downward creating the four walls of the pyramid 4 which is positively(+) charged and fused to the docking chambers and the pyramid base 2 which is negatively(−) charged. One of the pyramid walls 5 contains solar cells as an energy source.

While the invention has been described with reference to the preferred embodiment, it will be understood that there is no intention to limit the invention to the particular embodiment shown. It is intended to include various alternative constructions included within the scope of the appended claims.

I claim:

1. A space station structure designed as a pyramid which is erected in a manner that encapsulates an Earthbound land mass (i.e. homes, towns and sanctuaries) providing an internal terrestrial environment including air circulation systems, temperature/pressure control, solar energy, radiation protection, artificial gravity and docking chambers for spacecrafts entering or leaving the structure.

2. A space station structure as claimed in claim 1 where a synthetic rubber polymer solution is dispersed underground to form the pyramid base.

3. A space station structure as claimed in claim 1 in which the edges of the pyramid structure consists of a tubular waterproof fabric capable of transporting a liquid solution necessary for constructing the pyramid walls.

4. A space station structure as claimed in claim 1 where a synthetic rubber polymer solution is dispersed from the apex and cascades downward, creating the pyramid walls.

5. A space station structure as claimed in claim 1 where the walls of the pyramid are fused with the base perimeter.

6. A space station structure as claimed in claim 1 where conditions for sustaining life are initiated through:
a. air temperature and pressure systems
b. air circulation and oxygen generator systems
c. artificial gravity through static electric forces

7. A space station structure as claimed in claim 1 where the erected pyramid structure containing an Earthbound land mass is elevated into Earth's orbit.
